(19) United States
(12) Patent Application Publication
(10) Pub. No.: US 2026/0244888 A1
(43) Pub. Date: Aug. 20, 2026

(54) Methods, Apparatuses, and Systems for Contact Lenses Having Writable Optical Patterns

(71) Applicant: Telefonaktiebolaget LM Ericsson (publ), Stockholm (SE)

(72) Inventors: Alexander Hunt, Limhamn (SE); Andreas Kristensson, Södra Sandby (SE)

(21) Appl. No.: 19/157,147

(22) PCT Filed: Feb. 23, 2023
(86) PCT No.: PCT/SE2023/050162

§ 371 Date: Aug. 15, 2025

(51) Int. Cl. G06K 19/06; B41J 2/44; B41J 2/47; B41J 3/407; B41J 3/44; B41J 29/393; B41M 5/46; G02C 7/04; G06K 7/14

(52) U.S. Cl. CPC G06K 19/06131; B41J 2/442; B41J 2/47; B41J 3/40731; B41J 3/44; B41J 29/393; B41M 5/46; G02C 7/04; G06K 7/1404; B41M 2205/18; G02C 2202/16

(57) ABSTRACT

Methods, apparatuses, and systems disclosed herein relate to a contact lens that includes one or more writable regions for recordation of an optical pattern, and further relate to writing and reading such patterns, in the context of user authentication, for example. Embodiments include one-time writable contact lens, which may be prewritten during manufacture or written post-manufacture, and further include rewritable contact lens, which may be rewritten multiple times. Multiple advantages attend the disclosed embodiments, including cost savings, simplicity, and reliability, as compared to smart lenses that require electronics, displays, and supporting power sources.

### TECHNICAL FIELD

Methods, apparatuses, and systems disclosed herein relate to a contact lens that includes one or more writable regions for recordation of an optical pattern, and further relate to writing and reading such patterns, in the context of user authentication, for example.

### BACKGROUND

Biometric authentication offers several advantages, including security and convenience. However, biometric authentication brings with it privacy concerns, particularly in certain authentication contexts.

Alternatives that offer at least some of the convenience while avoiding the concerns of personal privacy attending biometric scanning include the use of smart lenses that exhibit authentication patterns, such as Quick Response (QR) codes. Smart lenses, particularly a smart contact lens worn on the eye of a user, offer particular points of convenience in the context of user authentication but bring with them technical complexity and expense.

### SUMMARY

Methods, apparatuses, and systems disclosed herein relate to a contact lens that includes one or more writable regions for recordation of an optical pattern, and further relate to writing and reading such patterns, in the context of user authentication, for example. Embodiments include one-time writable contact lens, which may be prewritten during manufacture or written post-manufacture, and further include rewritable contact lens, which may be rewritten multiple times. Multiple advantages attend the disclosed embodiments, including cost savings, simplicity, and reliability, as compared to smart lenses that require electronics, displays, and supporting power sources.

One embodiment comprises a contact lens for an eye of a wearer. The contact lens comprises first and second outer surfaces, the first outer surface facing outward, away from the eye of the user when the contact lens is worn by the user, and the second outer surface facing towards and contacting the eye when the contact lens is worn by the user. The contact lens includes one or more writable regions, each writable region comprising one or more layers of material disposed between the first and second outer surfaces and being laser writable, for formation of an optical pattern readable through the first outer surface.

Another embodiment comprises an apparatus configured for recordation of an optical pattern in a contact lens containing one or more writable regions for recordation of the optical pattern. Recordation supports detection of the pattern by an external observer device, such as for authentication of a user wearing the contact lens. The apparatus comprises a housing containing a lens carrier, a pattern-writing subsystem, and a control subsystem. The lens carrier is configured to hold the contact lens and the pattern-writing subsystem is configured to record the optical pattern in the contact lens as held on the carrier, using laser stimulation of at least one writable region among the one or more writable regions of the contact lens, or other suitable recording technology. The pattern-writing sub-system includes one or more lasers configured to output laser light, and a lens assembly configured to direct the laser light output from the one or more lasers onto the contact lens, for recordation of the optical pattern. The control subsystem includes controller circuitry configured to control the pattern-writing subsystem.

Another embodiment comprises a system that includes a contact lens, an apparatus, and an observer device. The contact lens is configured for recordation of an optical pattern via laser stimulation of one or more writeable regions of the contact lens. Correspondingly, the apparatus is configured to store information defining the optical pattern to be recorded in the contact lens and record the optical pattern in the contact lens as a recorded optical pattern. The observer device is configured to obtain a detected optical pattern from the contact lens, based on optical detection of the contact lens as worn on the eye of a wearer, and authenticate the wearer in dependence on determining that the detected optical pattern matches a reference optical pattern known by the observer device. For example, the observer device receives information from a remote server, or a personal computing device associated with the wearer, where the received information indicates the reference optical pattern.

A related embodiment comprises a method of authentication a user, where the method is performed by an observer device. The method comprises the observer device detecting an optical pattern recorded in a contact lens via laser stimulation of one or more writable regions of the contact lens, comparing the detected optical pattern with a reference optical pattern, and deeming the user to be authenticated responsive to the detected optical pattern matching the reference optical pattern.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a perspective view of a contact lens having one or more writable regions, according to an example embodiment.

FIG. 2 is a front view of the contact lens shown in FIG. 1.

FIG. 3 is a diagram showing internal layers of a contact lens used to form one or more writable regions, in an example embodiment.

FIGS. 4A, 4B, 5A, and 5B are example cross-sectional depictions of layers associated with forming one or more writeable regions in a contact lens.

FIG. 6 is a front view of a contact lens with an array of writable regions, according to one embodiment.

FIGS. 7-9 are block diagrams of an apparatus for recording an optical pattern in a contact lens, according to an example embodiment.

FIG. 10 is a block diagram of a system according to one embodiment, where the system includes a contact lens, an apparatus for recording an optical pattern in the contact lens, and an observer device configured for detection and verification of the optical pattern recorded in the contact lens.

FIG. 11 is a logic flow diagram illustrating a method of operation by an observer device configured for detection of an optical pattern recorded in a contact lens, according to one embodiment.

FIGS. 12-14 are logic flow diagrams illustrating methods of operation by an apparatus configured for recordation of an optical pattern in a contact lens, according to respective example embodiments.

### DETAILED DESCRIPTION

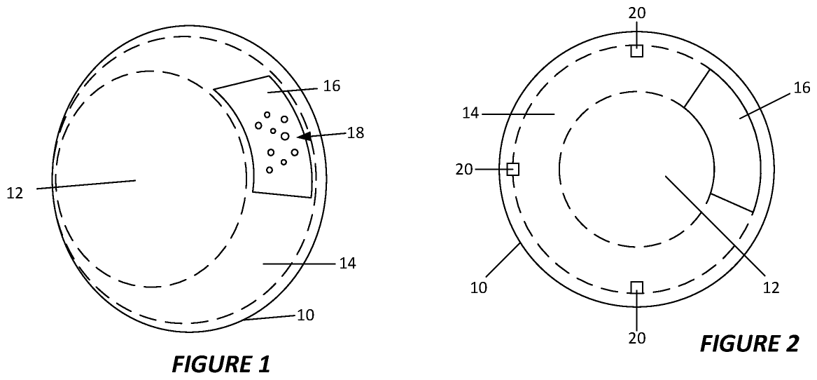

FIG. 1 is a perspective view of a “writable” contact lens 10 according to one embodiment. The term “writable” as used herein means that the contact lens 10 includes one or more areas that are responsive to laser stimulation, for recordation of an optical pattern.

The contact lens 10 includes a central area 12 that is optically clear and may be optically corrective with respect to an eye of an intended wearer. An annular area 14 surrounds the central area 12, with the annular area 14 containing one or more writeable regions 16. The one or more writable regions 16 are responsive to laser stimulation, for recordation of an optical pattern 18.

FIG. 1 shows only an example of the optical pattern 18, and the particulars of the optical pattern 18 may vary in dependence on any one or more factors, such as the number, size, or arrangement of the writable regions 16 included in the contact lens 10, the security context in which the optical pattern 18 is used, or the capabilities of the device that writes or reads it. In one or more examples, the optical pattern 18 is a Quick Response (QR) code. As a general proposition, the optical pattern 18 may be understood as some form of a reflectance pattern—e.g., a pattern of reflective areas and non-reflective or less reflective areas-that is detectable by an observer device. The reflected light may be ambient light or may be a scanning light output by the observer device. Note that the light at issue here may be in the non-visible spectrum, depending, for example, on the configuration of the observer device.

FIG. 2 is a front view of the contact lens 10, with FIG. 2 adding further example details. Namely, in one or more embodiments, the contact lens 10 includes one or more registration markers 20, which may comprise a set of reflective or non-reflective areas at defined locations. The registration markers 20 provide a frame of reference for an observer device to locate the optical pattern 18, or to determine the orientation of the observer device relative to the contact lens 10. Unlike retinal scans, depending upon the detection resolution of the observer device and the size and resolution of the optical pattern 18, the optical pattern 18 may be read from a distance, e.g., one or more meters of separation between the contact lens 10 and the observer device. Such arrangements have obvious hygienic and convenience advantages over retinal scanning systems.

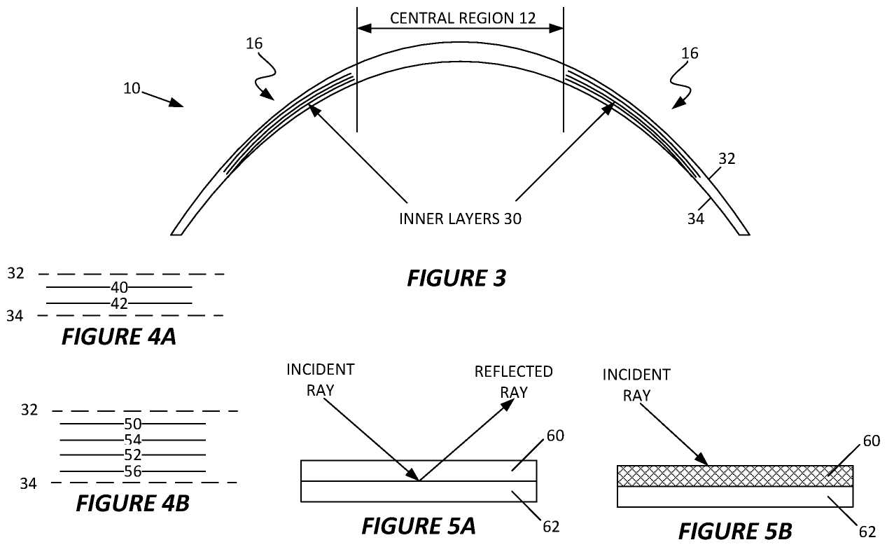

FIG. 3 illustrates further example details of the contact lens 10, in which one or more inner layers 30 are used to form the writable regions 16. In particular, the contact lens 10 comprises first and second outer surfaces 32 and 34. The first outer surface 32 faces outward, away from the eye of the user when the contact lens 10 is worn by the user, and the second outer surface 34 faces towards and contacting the eye when the contact lens 10 is worn by the user. Each of the one or more writable regions 16 comprises one or more inner layers 30 of material disposed between the first and second outer surfaces 32 and 34 and is being laser writable, for formation of the optical pattern 18. Notably, the structure of the contact lens 10 and manner of recordation of the optical pattern 18 is such that the optical pattern 18 is readable through the first outer surface 32. In other words, the optical pattern 18 is detectable by an observer device having a line of sight to the contact lens 10, as worn on the eye of the user.

In one or more embodiments, the one or more writable regions 16 are one-time writable. For example, as seen in FIG. 4A, the inner layers 30 may comprise a dye layer 40 that overlays a reflective layer 42, where “overlays” is used with respect to the first outer surface 32. The corresponding dye and reflective layers 40 and 42 may or may not be continuous—i.e., they may form respective continuous layers of materials within the annular area 14 of the contact lens 10, or they may comprise two or more non-continuous areas of material, like individual “islands” within the annular area 14.

Broadly, in one or more embodiments, each of the one or more writable regions 16 comprises a layer 42 of reflective material that is, with respect to the first outer surface 32, overlaid with a dye layer 40, where the dye layer 40 is responsive to laser stimulation. For example, the dye forming or held in the dye layer 40 is transparent until stimulated by laser light of sufficient intensity and, possibly, at a particular wavelength. Upon stimulation, the dye darkens, thus creating areas of non-reflectivity or reduced reflectivity, at least with respect to light in one or more frequency ranges.

In one or more embodiments, the one or more writable regions 16 are rewritable. For example, as seen in FIG. 4B, the inner layers 30 may comprise a pair of dielectric layers 50 and 52 that encapsulate a phase-change layer 54, where the encapsulated phase-change layer 54 overlays a reflective layer 56. As described above, these inner layers may or may not be continuous—i.e., they may form respective continuous layers of materials within the annular area 14 of the contact lens 10, or they may comprise two or more non-continuous areas of material, like individual “islands” within the annular area 14.

Phase-change material comprised in the phase-change layer 54 is transparent in a first phase and is non-transparent or at least substantially less transparent in a second phase. Stimulation of the phase-change material at a first laser power level causes the phase-change material to change from the first phase to the second phase, and stimulation of the phase-change material at a different, second laser power level causes the phase-change material to change from the second phase back to the first phase, after cooling.

FIG. 5A illustrates phase-change material 60 in the first phase, in which the phase-change material allows an incident light ray to pass through the phase-change layer 54 and strike reflective material 62 in the reflective layer 56. The reflective layer 56 reflects the incident light ray back as a reflected light ray. FIG. 5B illustrates the phase-change material 60 in the second phase, in which the phase-change material 60 obscures the reflective material 62 underlying it.

Thus, in one or more embodiments, each of the one or more writable regions 16 comprises a layer 56 of reflective material that is, with respect to the first outer surface 32, overlaid by a phase-change layer 54, with the phase-change layer 54 being reversibly responsive to laser stimulation.

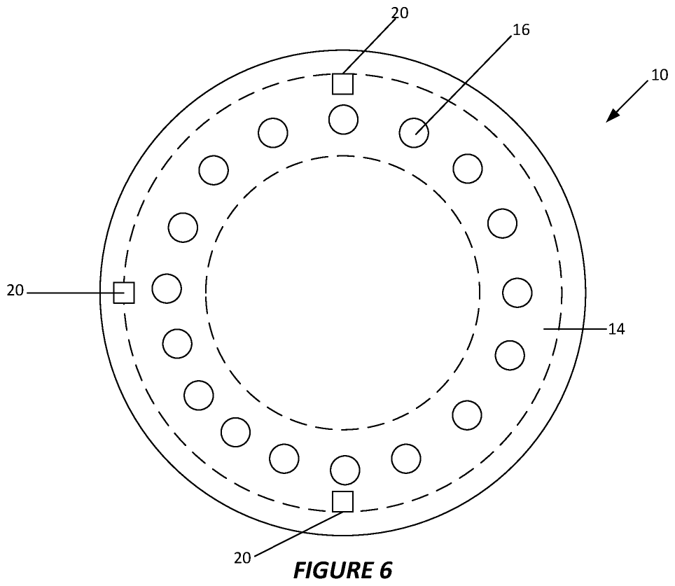

As noted, the one or more writable regions 16 are positioned within the annular area 14 surrounding the central area 12 of the contact lens 10. As further noted and as shown in the example arrangement of FIG. 6, in one or more embodiments, the one or more writable regions 16 comprise an array of individually writable regions 16, each individually writable region 16 providing one among a plurality of optical bits that collectively define the optical pattern 18, which is not shown explicitly in the diagram. An “optical bit” in this context has one of two states, with the particular state being defined by whether the writable region 16 representing the optical bit is reflective or non-reflective, where “non-reflective” encompasses any level or degree of reduced reflectance that is reliably distinguishable from a nominal or full reflectance condition.

Thus, recording an optical pattern 18 in the contact lens 10 shown in FIG. 6 comprises choosing which writable regions 16 in the array of writable regions 16 to stimulate. Assuming that the contact lens 10 is one-time writable and that the default or initial condition of each writable region 16 is reflective, recording the optical pattern 18 in the contact lens 10 of FIG. 6 comprises choosing which writable regions 16 to darken via laser stimulation. Assuming that the contact lens 10 is rewritable, then recording the optical pattern 18 in the contact lens 10 of FIG. 6 comprises, for example, erasing all writeable regions 16—resetting them to their reflective state—and then choosing which ones to darken. For both one-time writable and rewritable types of lenses, one or more embodiments support “delta writing.” That is, provided that the optical pattern 18 currently recorded in the contact lens 10 is known, incremental writing may be supported, wherein delta changes are made to update the recorded pattern in the contact lens 10. A nice aspect of delta writing in the context of one-time writable lenses is that the same lens may be reused one or more times, with each reuse based on incremental changes to the previously-written pattern.

In the rewritable context, an example contact lens 10 has one or more writable regions 16 comprising one or more regions of reflective material disposed within an annular area 14 surrounding a central area 12 of the contact lens 10, with the reflective material internal to the contact lens 10 and carried between the first outer surface 32 and the second outer surface 34. The contact lens 10 further comprises one or more regions of a phase-change material correspondingly overlaying the one or more regions of reflective material with respect to the first outer surface 32. For formation of the optical pattern 18, laser stimulation reversibly changes stimulated areas of the phase-change material between a first phase in which the phase change material is transparent and a second phase in which the phase-change material is opaque.

Turning back to FIGS. 4B, 5A, and 5B momentarily, reflective material 62 may be disposed in a reflective layer 56 of the contact lens 10 and phase-change material 60 may be disposed in a phase-change layer 54 of the contact lens 10. The reflective and phase-change layers 56 and 54 exist between first and second outer layers that respectively define the first and second outer surfaces 32 and 34 of the contact lens 10.

As noted, in embodiments where the one or more writable regions 16 are rewritable, the one or more writable regions 16 may be formed as one or more regions of reflective material overlaid by a corresponding one or more regions of phase-change material. For example, there may be an array of reflective regions and a corresponding array of individual phase-change regions, each one overlaying a respective one of the reflective regions. In such embodiments, the optical pattern 18 is recorded in the contact lens 10 by selective laser stimulation of individual ones of the phase-change regions.

Alternatively, the contact lens 10 may include a single contiguous region of reflective material with a single contiguous region of phase-change material corresponding to and overlaying the single contiguous region of reflective material, such that the optical pattern 18 is recorded in the contact lens 10 by patterned laser stimulation of select areas within the single contiguous region of phase-change material. A larger, contiguous writable region 16 may be advantageous for the formation of complex patterns, such as a QR code. And, again, the contact lens 10 in one or more embodiments has two or more fixed registration markers 20, for use by an observer device in detecting the optical pattern.

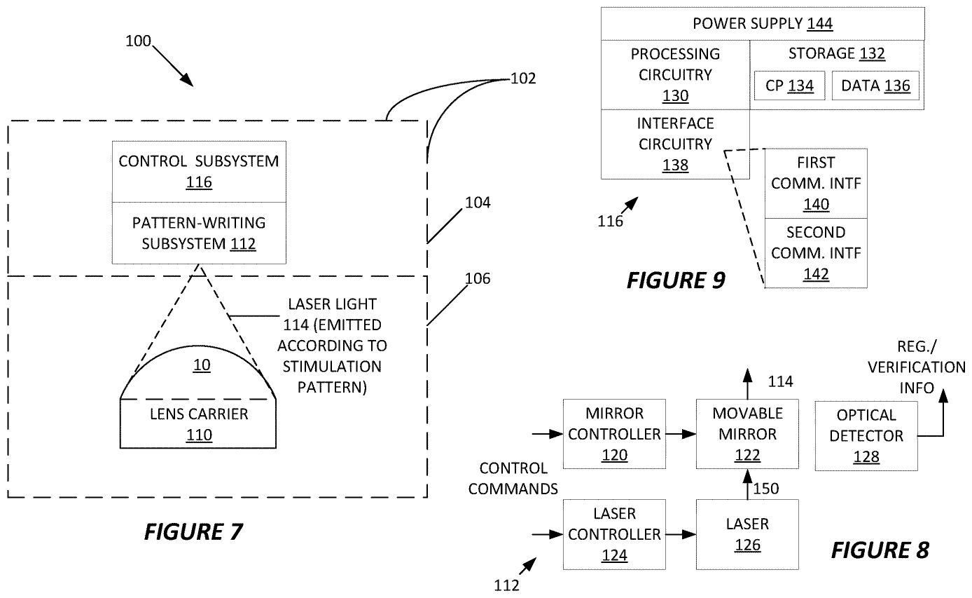

FIG. 7 illustrates an apparatus 100 for writing an optical pattern to a writable contact lens 10, according to an example embodiment. Specifically, the apparatus 100 is configured for recordation of an optical pattern 18 in a contact lens 10 containing one or more writable regions 16 for recordation of the optical pattern 18, for detection by an external observer device. The apparatus 100 in the depicted example embodiment comprises a housing 102, comprising a top portion or lid 104 and a base portion 106. The top portion 104 comprises a hinged lid, for example.

The apparatus 100 further comprises a lens carrier 110, a pattern-writing subsystem 112, which emits laser light 114, and a control subsystem 116. The pattern-writing subsystem 112 and the control subsystem 116 may be carried in the top portion 104 of the housing 102, with the lens carrier 110 carried in the base portion 106. As shown, the lens carrier 110 is configured to hold the contact lens 10, e.g., for pattern writing and for general storage purposes. Although not shown, the apparatus 100 may include irrigation or cleaning features for the contact lens 10.

The pattern-writing subsystem 112 is configured to record an optical pattern 18 in the contact lens 10 as held on the lens carrier 110, via laser stimulation of at least one writable region 16 among the one or more writable regions 16 of the contact lens 10. The pattern-writing sub system 112 comprises one or more lasers configured to output the laser light 114, and a lens assembly configured to direct the laser light 114 output from the one or more lasers onto the contact lens 10, for recordation of the optical pattern 18.

FIG. 8 illustrates example details for the pattern-writing subsystem 112, including a mirror controller 120 that controls a movable mirror 122 responsive to control commands generated by the control subsystem 116. Manipulation of the movable mirror 122 in turn steers or otherwise moves the laser light 114, for formation of the optical pattern 18 in the contact lens 10, while the contact lens 10 is positioned on the lens carrier 110. A laser controller 124, also responsive to control commands from the control subsystem 116 controls one or more lasers 126. In embodiments involving one-time writable contact lenses, control of the laser(s) 126 includes on/off control and steering. In embodiments involving rewritable contact lenses, control of the laser(s) 126 includes on/off control and steering, along with power control. For example, pattern writing uses a first laser power level and pattern erasure uses a second power level that is, for example, higher than the first power level.

The pattern-writing subsystem 112 in one or more embodiments includes an optical detector 128 that is configured to detect the registration marker(s) 20 in the contact lens 10. Detecting the registration marker(s) 20, which may be understood as a type of fiducials, allows the control subsystem 116 to receive information indicating the presence and/or orientation of the contact lens 10 on the lens carrier 110. The control subsystem 116 may adapt its control of the pattern-writing subsystem 112 according to the detected orientation of the contact lens 10 or it may prompt the user to reorient the contact lens 10, according to defined, nominal orientation.

FIG. 9 illustrates example details for the control subsystem 116, wherein it includes processing circuitry 130 that is associated with storage 132. In one or more embodiments, the storage 132 stores one or both of a computer program (“CP”) 134 or configuration data (“DATA”) 136. Further included in the example implementation of the control subsystem 116 is interface circuitry 138, which may include one or more communication interfaces. For example, the interface circuitry 138 includes a first communication interface 140 and a second communication interface 142. The first communication interface 140 comprises, for example, a Wi-Fi or other wireless Local Area Network (LAN) interface, for coupling the apparatus 100 to the Internet via a local wireless LAN. The second communication interface 142 comprises, for example, a Near Field Communications (NFC) wireless interface, a Bluetooth interface, or other local or Personal Area Network (PAN) radio interface, for communicating with a person computing device (PCD) associated with a wearer of the contact lens 10.

The processing circuitry 130 comprises fixed circuitry or programmatically configured circuitry, or a mix of both. In an example implementation, the processing circuitry 130 comprises any one or combination of one or more microprocessors, one or more Field Programmable Gate Arrays (FPGAs), one or more Application Specific Integrated Circuits (ASICs), one or more Complex Programmable Logic Devices (CPLDs), one or more Systems-on-a-Chip (SOCs), or other digital processing circuitry. In at least one embodiment, the processing circuitry 130 includes one or more general-purpose microprocessors that are specially adapted to control the apparatus 100 as described herein, based on execution of computer program instructions stored in the storage 132. To that end, the storage 132 comprises one or more types of computer readable media, such as a mix of volatile memory for program execution and non-volatile memory for longer-term storage of program instructions and data. Such data includes, for example, information indicating or defining one or more optical patterns 18, along with any supporting information, such as validity dates.

The apparatus 100 may further include a power supply 144. For example, the power supply 144 receives mains power or battery power and provides one or more regulated voltages for powering the control subsystem 116 and the pattern-writing subsystem 112.

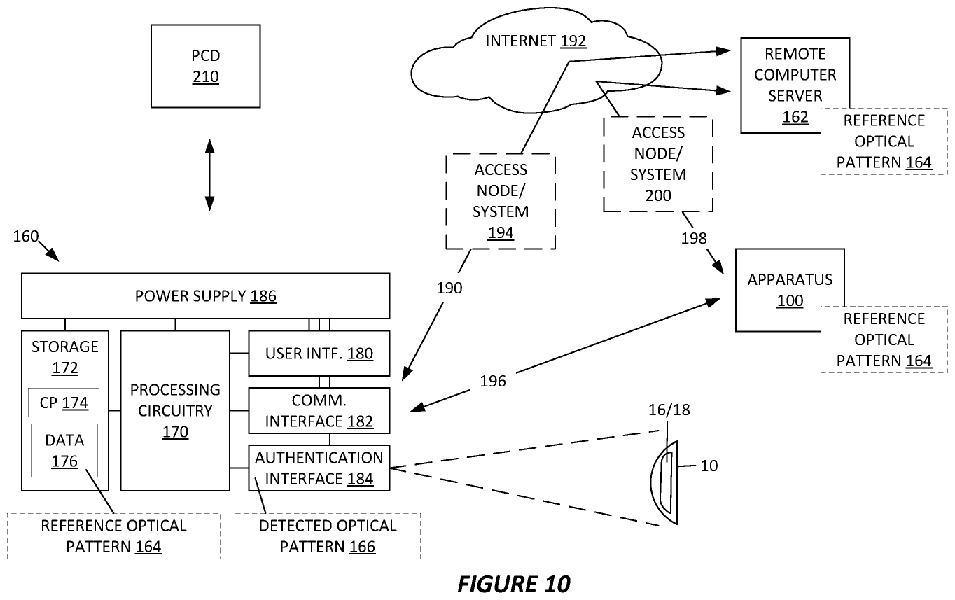

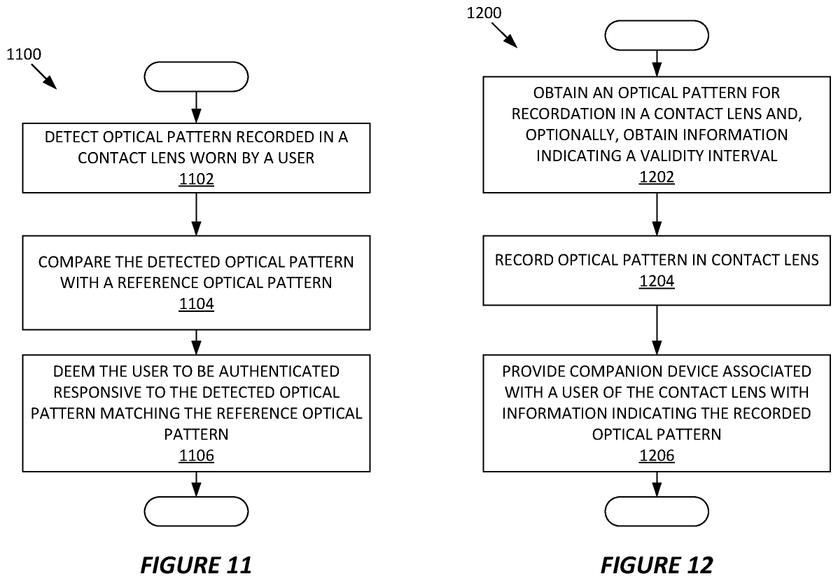

FIG. 10 illustrates an example implementation of an overall “system” that includes at least a contact lens 10 that includes one or more writable regions 16 and an apparatus 100 as described in the context of FIGS. 7-9. The system may be considered to further include an observer device 160 and a remote computer server 162.

To understand user authentication operations supported by the illustrated system, the diagram illustrates three different optical patterns: the optical pattern 18 that is recorded in the contact lens 10, a reference optical pattern 164, and a detected optical pattern 166. Note that the optical pattern 18 recorded in the contact lens 10 is a literal pattern of optical information—e.g., a reflectance pattern written into the writable region(s) 16 of the contact lens 10—whereas the reference optical pattern 164 and the detected optical pattern 166 shall be understood as stored data representing the corresponding optical patterns.

The reference optical pattern 164 is the optical pattern that is then valid. For example, the remote server 162 may generate or select a new optical pattern on a daily basis, a weekly basis, or using some other interval, with there being a respective valid optical pattern for each such interval. FIG. 10 presumes an attempted authentication of the wearer of the contact lens 10 by the observer device 160 during the validity period of the depicted reference optical pattern 164. If the wearer of the contact lens 10 deposited the contact lens 10 in the apparatus 100 during the validity period of the reference optical pattern 164, then the apparatus 100 will have written the reference optical pattern 164 into the contact lens 10, meaning that the optical pattern 18 recorded in the contact lens 10 will be the reference optical pattern 164. However, if the wearer did not deposit the contact lens 10 in the apparatus 100 during the validity period of the reference optical pattern 164 or if the contact lens 10 otherwise has an outdated optical pattern 18, then it will be understood that the optical pattern 18 recorded in the contact lens 10 will not match the reference optical pattern 164.

Correspondingly, the detected optical pattern 166 is obtained by the observer device 160 based on the wearer of the contact lens 10 coming within the detection range of the observer device 160 and the observer device 160 reading the optical pattern 18 that is recorded in the writable region(s) 16 of the contact lens 10. The detected optical pattern 166 will match the reference optical pattern 164 only if the recorded optical pattern 18 is the reference optical pattern 164 and no errors occurred in the optical detection. The observer device 160 may prompt the wearer to come closer or reposition herself responsive to the detected optical pattern 166 not matching the reference optical pattern 164, or it may otherwise make several read attempts before declaring a mismatch.

In any case, the observer device 160 deems the wearer of the contact lens 10 to be authenticated in response to the detected optical pattern 166 matching the reference optical pattern 164 and deems the wearer not to be authenticated in response to a mismatch. The observer device 160 may perform one or more types of access control or other operations conditioned on successful authentication of the wearer or may interface with other devices or systems that provide authentication-based controls. Note that reading the contact lens 10 may be based on the observer device 160 detecting reflected ambient light or may be based on the observer device 160 including or otherwise controlling an illumination source that illuminates the eye of the wearer. Detection range depends on multiple factors, such as the resolution of the camera or other sensor used by the observer device for detecting the optical pattern 18 recorded in the contact lens 10, and the resolution (size, pitch) of the recorded optical pattern 18.

In an example implementation, the observer device 160 comprises processing circuitry 170 and associated storage 172, e.g., for storing one or more computer programs 174 and data 176, such as the reference optical pattern 164. The observer device 160 may further include a user interface 180, which may be configured for interacting with the wearer of the contact lens 10 or a person tasked with using the observer device 160 for authenticating the wearer. Still further, the observer device 160 may include communication interface 182, an authentication interface 184, and a power supply 186.

The communication interface 182 comprises one or more communication interfaces, e.g., a first radio communication interface for establishing a communication link 190 to the remote server 162 via the Internet 192. An access node or system 194 may support the communication link 190. For example, the communication interface 182 includes a cellular radio modem for connecting to an access node of a cellular communication network that provides access to the Internet 192. Alternatively, the communication link 190 may be based on a local wireless network, such as a local Wi-Fi network, with the communication interface 182 including Wi-Fi circuitry.

The communication interface 182 additionally, or alternatively, includes a communication interface that is configured for communicating with the apparatus 100. That is, the observer device 160 obtains the reference optical pattern 164 from the remote server 162 in one or more embodiments but may obtain it from the apparatus 100 in at least one embodiment, or under at least some circumstances. For example, the communication interface 182 includes a Bluetooth communication circuit or other local radio communication circuit for establishing a communication link 196 with the apparatus 100. And, as earlier explained, the apparatus 100 in one or more embodiments includes a communication interface that is configured to establish a communication link 198 with the remote server 162, where such link may be established through an access node or system 200, e.g., a Wi-Fi or cellular access point.

FIG. 10 can be understood as one example of a system that includes a contact lens 10 that is configured for recordation of an optical pattern 18 via laser stimulation of one or more writeable regions 16 of the contact lens 10, with the system further including an apparatus 100. The apparatus 100 is configured to store information defining the optical pattern 18 to be recorded in the contact lens 10 and record the optical pattern 18 in the contact lens 10 as a recorded optical pattern. The system may further include an observer device 160 that is configured to obtain a detected optical pattern 166 from the contact lens 10, based on optical detection of the contact lens 10 as worn on the eye of a wearer, and authenticate the wearer in dependence on determining that the detected optical pattern 166 matches a reference optical pattern 164 known by the observer device 160. The observer device 160 knows the reference optical pattern 164, based on the observer device 160 receiving information from a remote server 162 or a from a PCD associated with the wearer, e.g., PCD 210 shown in FIG. 10. The PCD 210 comprises, for example, a smartphone, tablet, or laptop computer, including processing circuitry and communication circuitry.

Consider an example scenario where the contact lens 10 in question is of the rewritable variety and is used for authenticating an employee for access to a restricted area. The remote server 162 chooses a new reference optical pattern 164 each day, with the wearer of the contact lens 10 placing the contact lens 10 in the apparatus 100 overnight or each morning before leaving for work, such that each day the optical pattern recorded in the contact lens 10 matches the reference optical pattern 164 that is valid for that day.

Of course, the above scenario may be accommodated using potentially cheaper one-time-writable contact lens. For example, the employee obtains a pack of thirty contact lens 10 for the month, where the contact lenses 10 are disposable daily lenses that are one-time writable. In this scenario, the employee places a fresh (blank) contact lens 10 in the apparatus 100 each morning, and the apparatus 100 writes the reference optical pattern 164 valid for that day.

In the rewritable case, the one or more writable regions 16 of the contact lens 10 are rewritable, based on pattern recordation being performed at a first laser power level and pattern erasure being performed at a second laser power level. The pattern-writing subsystem 112 is controllable to perform either pattern recordation or pattern erasure. Correspondingly, the control subsystem 116 of the apparatus 100 is configured to control whether the pattern-writing subsystem 112 operates in a recordation mode or an erasure mode. The control subsystem 116 in one or more embodiments is configured to control whether the pattern-writing subsystem 112 operates in the recordation mode or in the erasure mode, in response to control inputs received by the apparatus 100. Additionally, or alternatively, the apparatus 100 automatically performs erasure any time it is writing a new pattern to a rewritable contact lens. Any given contact lens 10 may include a marking indicating whether it is one-time-writable or rewritable, for detection by the apparatus 100, or a user may provide an input indicating whether a contact lens deposited into the apparatus 100 is one-time-writable or rewritable.

As noted, the control subsystem 116 of the apparatus 100 in one or more embodiments includes interface circuitry 138 for exchanging signaling with one or more external devices, by which the control subsystem 116 determines the optical pattern 18 to be recorded in the contact lens 10. For example, the interface circuitry 138 comprises a communication interface configured to communicatively couple the apparatus to a remote server 162 that decides the optical pattern. In one or more embodiments, the optical pattern 18 has a defined validity window and the control subsystem 116 is configured to erase the optical pattern 18 from the contact lens 10 responsive to a next placement of the contact lens 10 in the apparatus 100, after expiration of the defined validity window.

The control subsystem 116 in one or more embodiments is configured to receive signaling from time to time, indicating updates to the optical pattern 18. With respect to each update, the control subsystem 116 is configured to update the optical pattern 18 recorded in the contact lens 10, conditioned on the contact lens 10 being available in the apparatus 100 for rewriting during a validity window associated with the update. The interface circuitry of the control subsystem 116 may also include a radio interface configured for communicating with PCDs, for transfer of information indicating the optical pattern 18, from the apparatus 100 to the PCD. In at least one embodiment, the control subsystem 116 is configured to transfer the information indicating the optical pattern, responsive to authenticating cryptographic information provided by the PCD. Such operations may be based on Public Key Infrastructure (PKI) certificates, or a shared secret, or other cryptographic procedure.

Turning to example methods of operation, one embodiment comprises a method 1100 of authenticating a user, where the method 1100 is performed by an observer device, such as the observer device 160. The method 1100 includes: detecting (Block 1102) an optical pattern 18 that was recorded in a contact lens 10 via laser stimulation of one or more writable regions 16 of the contact lens, comparing (Block 1104) the detected optical pattern 166 with a reference optical pattern 164, and deeming (Block 1106) the user to be authenticated responsive to the detected optical pattern 166 matching the reference optical pattern 164.

The method 1100 may further comprise the observer device 160 receiving information indicating the reference optical pattern 164, from a remote server 162 that manages reference optical patterns and corresponding validity intervals for authentication of the user. Additionally, or alternatively, the method 1100 may include the observer device 160 receiving information indicating the reference optical pattern 164 via local radio communications with a PCD that is carried or worn by the user.

FIG. 12 illustrates an example method 1200 of operation by an apparatus that is configured to record an optical pattern 18 in a contact lens 10 that includes one or more writable regions 16 for such recordation. The method 1200 is performed, for example, by the apparatus 100 shown in FIGS. 7-9. The method 1200 includes: obtaining (Block 1202) an optical pattern for recordation in the contact lens and, optionally, obtaining information indicating a validity interval of the optical pattern; recording (Block 1204) the optical pattern in the contact lens; and providing (Block 1206) a companion device associated with the user of the contact lens with information indicating the recorded optical pattern. Here, the companion device is a smartphone or other PCD, for example, such as the PCD 210 shown in FIG. 10.

In at least one embodiment, providing the information to the companion device allows the companion device to transfer the information to an observer device, for use by the observer device in validating the optical pattern detected from the contact lens by the observer device. That is, secure transfer of pattern information from the apparatus that records the optical pattern to the companion device, and later secure transfer of that pattern information to the observer device, allows the observer device to treat the pattern information as the “reference optical pattern 164” described above, for validation of the detected optical pattern 166 obtained by the observer device reading the contact lens. This approach is convenient because the companion device travels with the wearer of the contact lens.

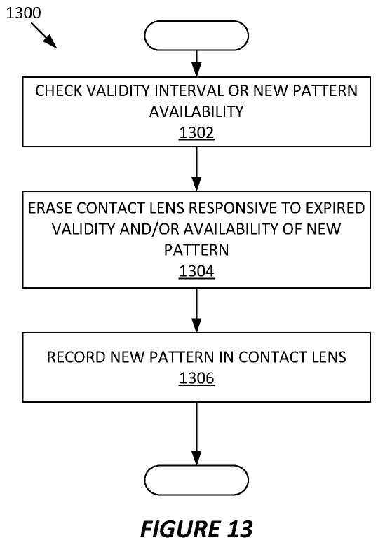

FIG. 13 illustrates another method 1300 of operation by an apparatus that is configured for writing an optical pattern to a contact lens having one or more writable regions that are rewritable. The method 1300 includes: checking (Block 1302) a validity interval or new pattern availability, erasing (Block 1304) the contact lens responsive to the validity interval being expired or there being a new pattern available, and recording (Block 1306) a new pattern in the contact lens.

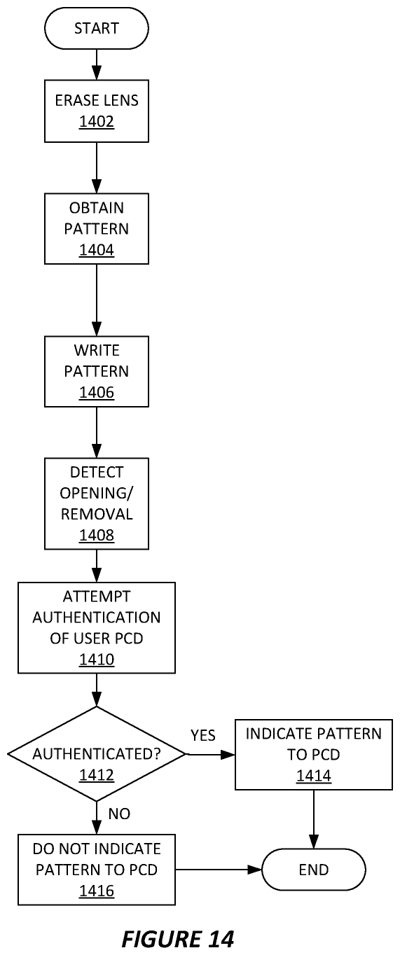

FIG. 14 illustrates yet another method 1400 of operation by an apparatus that is configured for writing an optical pattern to a contact lens having one or more writable regions that are rewritable. The method 1400 includes erasing (Block 1402) the contact lens, obtaining (Block 1404) an optical pattern to be written in the contact lens, writing (Block 1406) the optical pattern in the contact lens, detecting (Block 1408) opening of the apparatus or removal of the contact lens from the apparatus and, in response to that triggering event, attempting (Block 1410) authentication of a PCD associated with a user-the wearer of the contact lens. If the authentication of the PCD succeeds (YES from Block 1412), the method 1400 continues with the apparatus indicating (Block 1414) the pattern to the PCD, e.g., via local radio communications. If the authentication does not succeed (NO from Block 1412), the method 1400 continues with the apparatus not indicating (Block 1416) the pattern to the PCD.

The obtaining operation shown in Block 1404 comprises, for example, the apparatus reading the pattern from memory, e.g., such as where the apparatus is provisioned with or otherwise receives one or more optical patterns ahead of time, possibly with information about the validity period of each such pattern. In such cases, the apparatus checks the date or time and chooses the stored pattern that is valid for the current date/time. In one or more other embodiments, or under other operating circumstances, the apparatus obtains the pattern to be written based on receiving it from a remote server, e.g., responsive to the apparatus sending a request to the remote server.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-33. (canceled)

34. A contact lens for an eye of a wearer, the contact lens comprising:
first and second outer surfaces, the first outer surface facing outward, away from the eye of the user when the contact lens is worn by the user, and the second outer surface facing towards and contacting the eye when the contact lens is worn by the user; and
one or more writable regions, each writable region comprising one or more layers of material disposed between the first and second outer surfaces and being laser writable, for formation of an optical pattern readable through the first outer surface.

35. The contact lens according to claim 34, wherein each of the one or more writable regions comprises a layer of reflective material that is, with respect to the first outer surface, overlaid with a dye layer, the dye layer responsive to laser stimulation.

36. The contact lens according to claim 35, wherein each of the one or more writable regions comprises a layer of reflective material that is, with respect to the first outer surface, overlaid by a phase-change layer, the phase-change layer reversibly responsive to laser stimulation.

37. The contact lens according to claim 34, wherein the one or more writable regions are positioned within an annular area surrounding a central area of the contact lens.

38. The contact lens according to claim 37, wherein the one or more writable regions comprise an array of individually writable regions, each individually writable region providing one among a plurality of optical bits that collectively define the optical pattern.

39. The contact lens according to claim 34, wherein the one or more writable regions comprise one or more regions of reflective material disposed within an annular area surrounding a central area of the contact lens, the reflective material internal to the contact lens and carried between the first outer surface and the second outer surface, and further comprising one or more regions of a phase-change material correspondingly overlaying the one or more regions of reflective material with respect to the first outer surface, and, wherein, for formation of the optical pattern, laser stimulation reversibly changes stimulated areas of the phase-change material between a first phase in which the phase change material is transparent and a second phase in which the phase-change material is opaque.

40. The contact lens according to claim 39, wherein the reflective material is disposed in a reflective layer of the contact lens and the phase-change material is disposed in a phase-change layer of the contact lens, the reflective and phase-change layers existing between first and second outer layers respectively defining the first and second outer surfaces of the contact lens.

41. The contact lens according to claim 39, wherein the one or more regions of reflective material comprises an array of individual reflective regions and the one or more regions of phase-change material comprises a corresponding array of individual phase-change regions, each one overlaying a respective one of the reflective regions, such that the optical pattern is recorded in the contact lens by selective laser stimulation of individual ones of the phase-change regions.

42. The contact lens according to claim 39, wherein the one or more regions of reflective material comprise a single contiguous region of reflective material and the one or more regions of phase-change material comprise a single contiguous region of phase-change material corresponding to and overlaying the single contiguous region of reflective material, such that the optical pattern is recorded in the contact lens by patterned laser stimulation of select areas within the single contiguous region of phase-change material.

43. The contact lens according to claim 34, wherein the contact lens has two or more fixed registration markers, for use by an observer device in detecting the optical pattern.

44. An apparatus configured for recordation of an optical pattern in a contact lens containing one or more writable regions for recordation of the optical pattern, for detection by an external observer device, wherein the apparatus comprises:
a housing containing a lens carrier, a pattern-writing subsystem, and a control subsystem;
the lens carrier configured to hold the contact lens;
the pattern-writing subsystem configured to record the optical pattern in the contact lens as held on the carrier via laser stimulation of at least one writable region among the one or more writable regions of the contact lens, the pattern-writing sub-system comprising:
one or more lasers configured to output laser light; and
a lens assembly configured to direct the laser light output from the one or more lasers onto the contact lens, for recordation of the optical pattern; and
the control subsystem including controller circuitry configured to control the pattern-writing subsystem.

45. The apparatus according to claim 44, wherein the one or more writable regions are rewritable, based on pattern recordation being performed at a first laser power level and pattern erasure being performed at a second laser power level, and wherein the pattern-writing subsystem is controllable to perform either pattern recordation or pattern erasure.

46. The apparatus according to claim 45, wherein the control subsystem is configured to control, in response to control inputs received by the apparatus, whether the pattern-writing subsystem operates in a recordation mode or an erasure mode.

47. The apparatus according to claim 44, wherein the control subsystem further includes interface circuitry for exchanging signaling with one or more external devices, by which the control subsystem determines the optical pattern.

48. The apparatus according to claim 47, wherein the interface circuitry comprises a communication interface configured to communicatively couple the apparatus to a remote server that decides the optical pattern.

49. The apparatus according to claim wherein the optical pattern has a defined validity window and wherein the control subsystem is configured to erase the optical pattern from the contact lens responsive to a next placement of the contact lens in the apparatus, after expiration of the defined validity window.

50. The apparatus according to claim 44 wherein the control subsystem is configured to receive signaling from time to time, indicating updates to the optical pattern, and wherein, with respect to each update, the control subsystem is configured to update the optical pattern recorded in the contact lens, conditioned on the contact lens being available in the apparatus for rewriting during a validity window associated with the update.

51. The apparatus according to claim 44, wherein interface circuitry of the control subsystem includes a radio interface configured for communicating with personal computing devices, for transfer of information indicating the optical pattern, from the apparatus to the personal computing device.

52. A system comprising:
a contact lens configured for recordation of an optical pattern via laser stimulation of one or more writeable regions of the contact lens;
an apparatus configured to:
store information defining the optical pattern to be recorded in the contact lens; and
record the optical pattern in the contact lens as a recorded optical pattern; and
an observer device configured to obtain a detected optical pattern from the contact lens, based on optical detection of the contact lens as worn on the eye of a wearer, and authenticate the wearer in dependence on determining that the detected optical pattern matches a reference optical pattern known by the observer device, based on the observer device receiving information from a remote server or a personal computing device associated with the wearer.

53. A method of authentication a user, the method performed by an observer device and comprising:
detecting an optical pattern recorded in a contact lens via laser stimulation of one or more writable regions of the contact lens;
comparing the detected optical pattern with a reference optical pattern; and
deeming the user to be authenticated responsive to the detected optical pattern matching the reference optical pattern.
